(19) United States
(12) Patent Application Publication
(10) Pub. No.: US 2011/0036307 A1
(43) Pub. Date: Feb. 17, 2011

(54) Article of animal apparel for "Cat Paw Mittens to Prevent Scratching During Bathtime"

(76) Inventor: Sharena Sharee Walker, Buena Park, CA (US)

Correspondence Address: Sharena Walker, 7073 9th Street, Buena Park, CA, 90621, US

(21) Appl. No.: 12/541,962

(22) Filed: Aug. 16, 2009

(51) Int. Cl. A01K 13/00

(52) U.S. Cl. 119/851

(57) ABSTRACT

An article of animal apparel for “Cat Paw Mittens to Prevent Scratching During Bathtime” with a one piece mitten comprised flexible, cotton like, porous material, shaped to fit over each cat paw, front and rear with one user friendly design, a variable piece of dense reinforcement material affixed inside the mitten about the claw area for puncture resistance, an elastic, rubber band, or other expandable seam at the top of the mitten that when stretched open provides an opening for paw insertion, and when released provides instant closure or security, and a variable piece of material(s) on the bottom of the mitten that when wet becomes slippery taking away the cats ability to grip and execute a flee attempt giving the human control of the cat during bathtime. A preferred embodiment that maximizes fur exposure for the purpose of bathing while providing human protection from painful scratches during bathtime.

### BACKGROUND OF THE INVENTION

This invention relates generally to the field of an article of animal apparel and more specifically to Cat Paw Mittens to Prevent Painful Scratching During Bathtime. Cats have a natural aversion to water, particularly bathing. They usually struggle and use their claws as a means to escape during bathtime causing painful scratches or injury to the human. In lieu of this behavior and for other reasons, boots or protective boots for animals in general are well known in the arts. Boots have been created to prohibit an animals claws from causing damage. Others have been designed primarily to protect an animals paws from cold, heat, or injury. Furthermore, some have been developed to aid in the bathing of an animal.
U.S. Pat. No. 3,747,565 to Kellam discloses an article of animal apparel including a pair of boots adapted to be worn on the front paws of a cat to facilitate bathing.
U.S. Pat. No. 5,676,095 to Ralls discloses a protective covering for a cat's feet to prevent destructive behavior. The boots are made from a durable, puncture resistant material and are attached with gators.
U.S. Pat. No. 5,495,828 to Soloman et al. discloses a seamless animal boot with a hook and loop strap.
U.S. Des. Pat. No. 379,251 to Mezey (1997) discloses an animal boot with either one or two straps.
U.S. Des. Pat. No. 387,511 to Caditz (1997) discloses an animal boot with one strap.
U.S. Des. Pat. No. 382,378 to Stark (1997) discloses an animal boot with a built in attachment.
U.S. Pat. No. 2,446,371 to Jones (1946) discloses a slip on dog boot with a roughened sole to prevent slippage.
U.S. Pat. No. 5,408,812 to Stark (1995) discloses a dog boot with a foot portion and two attachment straps.
U.S. Pat. No. 5,452,685 to Thomas (1995) discloses a dog boot with a foot portion and a single hook and loop strap made out of puncture resistant material.
U.S. Pat. No. 4,457,261 to Marshall (1984) discloses a dog boot with a foot portion and a single hook and loop strap.

Prior inventions with the exceptions of a few such as U.S. Pat. No. 3,747,565 Kellam, and U.S. Pat. No. 5,676,095 Rails were designed specifically for a dog or broadly for dogs or cats, or broadly for an animal. U.S. Pat. No. 3,747,565 to Kellam discloses an article of animal apparel including a pair of boots adapted to be worn on the front paws of a cat to facilitate bathing. The boots are encompassed within mesh sleeves which are tied across the back of the animal. Kellams boots are placed on the front pair paws consisting of a boots and sleeve which extends along the legs and body portion and across the back. The sleeve portion restricts some of the direct exposure to of the fur during bath time, and does not facilitate the rear paws which cats will use to jump, push away, and claw when agitated during bathtime. Kellam does not facilitate the rear paws which can be even more of an issue during bathtime because of the strength in a cats hind legs. Kellams boots are connected by means of a snap fastener having a female portion disposed on the split end and a male portion disposed on the split end. Securing these boots suggest having to hold the cats paw for however long it takes to secure them possibly causing the cat some stress as the embodiment takes many steps to complete the application.

U.S. Pat. No. 5,676,095 to Ralls discloses a protective covering for a cat's feet to prevent destructive behavior. The boots are made from a durable, puncture resistant material and are attached with gators. Rails does not disclose protection from the rear claws. Rails invention is designed so that the paw coverings cannot be removed by an animal by mere pulling or chewing. Cats naturally pull away their paws when someone tries to touch or hold the paw. This natural aversion would make the prior invention technology not user friendly. The new user friendly invention is concerned with user friendliness, short term wear, easy application, and quick removal.

U.S. Pat. No. 5,495,828 to Solomon discloses a pet animal boot with an adjustable fastening strap is included for securing the boot to an animal's leg. Once again, this prior invention requires more than one step of securing the boot to the animal paw. Rawls invention relates to the protection of pet paws from harsh weather conditions preventing injury to the animal and is made to be waterproof. The new, user friendly invention is created to be porous to allow suds to penetrate during bathtime and is created to only prevent injury to the human by using a reinforcement material only about the claw area.

Previous invention methods of attaching the boots have had more than one step, some with several steps, and multi-articles making the application time inefficient and not user friendly.

The new invention is designed specifically for a cat paw. The new user friendly invention provides optimal results for a cat bathing with its custom shape, fit and size, that facilitates both front and back paws with one design allowing for maximum fur exposure. The new invention has a one step application process making the cat mittens user friendly and able to be attached by only one person, and also with one hand. Because of the expandable seam the application process can be done in a one step process by simply stretching the band open between the index fingers and thumb to create the opening for the paw, then releasing the mitten over the paw in one motion. Since the new invention has no straps, or loops, or ties, application is so simple that a child would find the application easy. The new invention is concerned with quick application, quick removal, and that they remain on the cats paws only for the duration of the bath averaging 10 to 20 minutes. The new invention gives maximum exposure to the fur coat for washing while also allowing paws to be subjected to washing because of the porous material used in the majority of the embodiment allowing sudsy water to penetrate about the mitten and rinsed. The new user friendly invention inhibits the use of all four clawed paws, not only the front paws. The new invention has added a pro-slip feature to the bottom of the mitten that will become slippery when wet; this will discourage the cat from fleeing by reducing its ability to grip; making the cat more submissive to the humans placement and hand hold. Because the new invention fits both front and rear paws, humans are protected while carrying the cat to and from bathtime where rear paws are likely to have contact with the human body.

### BRIEF SUMMARY OF THE INVENTION

The primary object of the invention is to provide protection from cats claws during bathtime and prevent painful scratches.

Another object of the invention is to provide a user friendly cat mitten for use during bathtime.

Another object of the invention is to provide a user friendly cat mitten that can be applied to the cat paw in one step.

A further object of the invention is to provide a practical cat mitten easily applied to a cat paw with no use of straps, snaps, or loops.

Yet another object of the invention is to provide a mitten capable of being applied with one hand and removed immediately.

Still yet another object of the invention is to provide claw protection so simple in application a child could use them.

Another object of the invention is to provide a temporary protection from cat claws.

Another object of the invention is to provide a more pleasant cat bathing experience to humans.

A further object of the invention is to provide a mitten that promotes slippage providing more human control of the cat.

Yet another object of the invention is to reduce a cats gripping ability during bathtime and reduce chance of escape by inhibiting their main defense mechanism.

Still yet another object of the invention is to provide a paw mitten specially designed to fit a cats paw.

Another object of the invention is to provide a style of cat paw mitten suitable for front and rear paws.

Another object of the invention is to provide an alternative to humans who clip cat nails for the purpose of bathtime.

A further object of the invention is to provide a cat mitten that allows for maximum exposure to fur during bathtime.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of animal apparel for “Cat Paw Mittens to Prevent Scratching During Bathtime” comprising: a one piece mitten comprised flexible, cotton like, porous material shaped to fit over each cat paw, front and rear with one user friendly design, a variable piece of dense reinforcement material affixed inside the mitten about the claw area for puncture resistance, an elastic, rubber band, or other expandable seam at the top of the mitten that when stretched open provides an opening for the paw, and when released provides the instant closure or security, and a variable piece of material(s) on the bottom of the mitten that when wet becomes slippery.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the cat paw mitten

FIG. 2 is a plan view of a human using their fingers to open the mitten for paw insertion

FIG. 3 is a clear view of the paw inside the mitten

FIG. 4 is an inside out view of the mitten depicting the inner reinforcement material

FIG. 5 is a clear view of a cat claws over the inner reinforcement material

FIG. 6 is the rear view of the mitten featuring the slippery embellishment

FIG. 7 is a car wearing the mitten, one on each paw

FIG. 8-12 are perspective views of the application process

FIG. 11-12 a perspective view of the one step application process

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

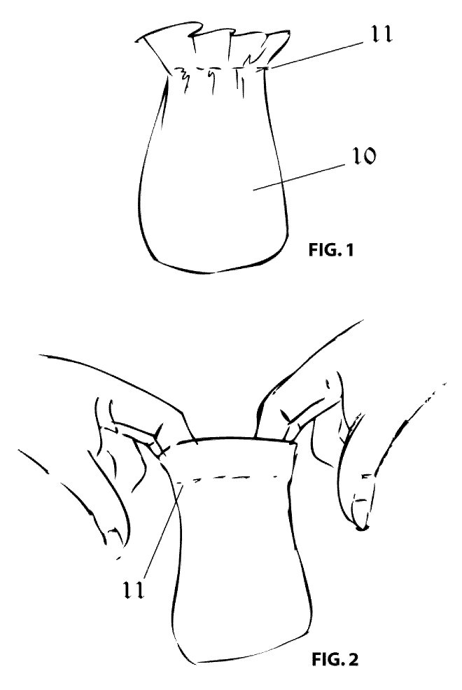

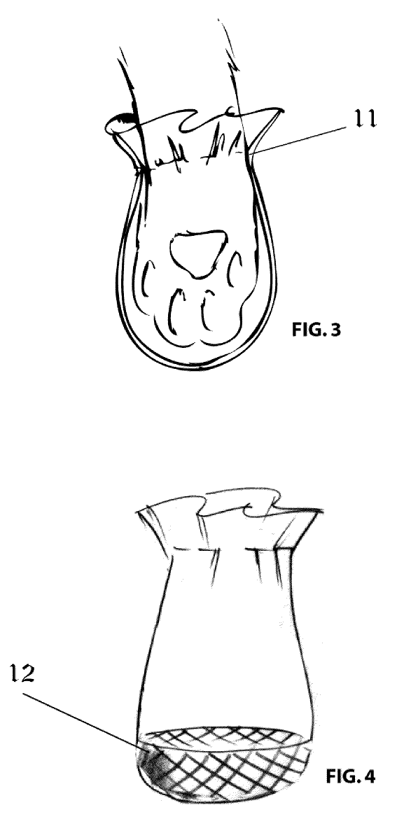

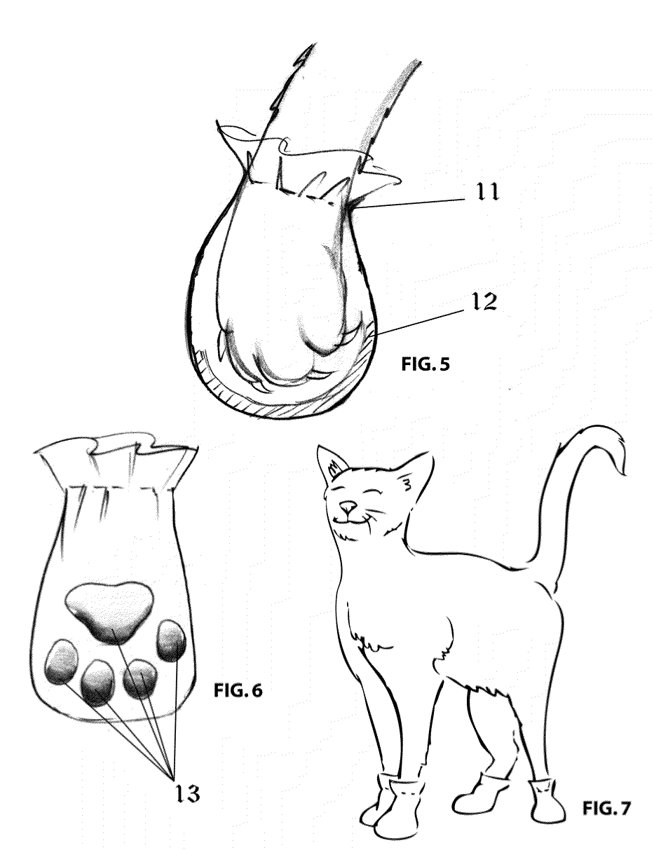

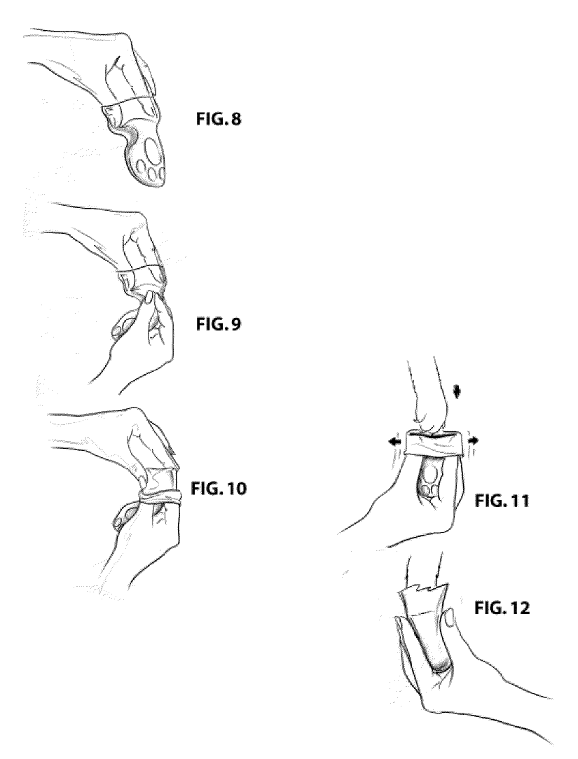

Turning first to FIG. 1 is shown the Cat Paw Mitten to prevent scratching during bathtime comprising of a one piece flexible, porous material shaped to fit a cats paw 10. One cat paw mitten fits all four cat paws. It is often the desire to clean the cats paws; a porous material, that will allow sudsy soap to pass through the material on to the paw to enable cleansing is preferred. The top of the said mitten 11 is an elastic material or some other expandable seam which enables the fabric to be stretched as in FIG. 2 to accommodate the size of the paw, enabling the cat paw to be inserted into the mitten. Following the preferred procedure is the second advantage of the elastic like expandable opening which is the almost instantaneous closure by simply releasing it. The seam in its closed state allows the article to fit snugly around the upper portion of the paw FIG. 5, 11, providing a grip that will withstand the cat attempting to shake off the mitten immediately, and withstand the water pressure during bathtime. The means of by which the closure is gathered around the paw gently catches some fur in the gathering process that also aids in the grip or security. The elastic like closure also facilitates quick application. Cats naturally pull away their paws when someone attempts to hold or pull on their paws. The elastic like material 11 creates such an instantaneous closure when released on to the paw, the process beats the cats reaction time. The elastic like closure also gives the added benefit by folding the seam over the humans first two index fingers and thumb, the band is able to be stretched open with one hand, and inserted over the paw, then quickly released, making the mitten applicable with one hand. This process of application FIG. 8-12 makes the mitten user friendly. Humans will find this useful because this will free the other arm to hold the cat. The elastic like opening and closure also makes removal simple without any ties or Velcro, or snaps to remove or undo. One motion downward removes the mitten from the paw immediately. FIG. 3 of the preferred embodiment illustrates the mitten on the cat paw.

The preferred embodiment allows for maximum fur exposure for bathing.

Turning to FIG. 4, the mitten is lined with a variable piece of reinforcement material about the claw area to reduce or completely reduce claws from penetrating the mitten and scratching the human during bathtime. This material is only attached about the claw area 12 to maintain the porosity of the majority of the mitten. The reinforcement material can be made from a simple extra layer of cotton material for light protection to puncture resistant materials such as Kevlar making the mitten puncture proof. When the cat is being bathed the animal may try to use its claws to escape but the layer of protection as illustrated in FIG. 5 will prohibit their claws from being used as a means of defense or escape.

The preferred embodiment features pieces of material sewn onto the bottom of the mitten to enhance slippage FIG. 6. This material is can be fabricated into the shapes of the paw pads. 5 separate pieces 13 creating an aesthetic look of a paw yet is for the function of becoming slippery when wet as a way to force the cat to concentrate on maintaining his balance during bathtime. The cat will not flee if he does not feel the grip under his feet to leap or run. The cat is forced to used his muscles and energy just to stand. It's general practice for the human to hold the cat with one hand while bathing him with the other hand. This feature gives the human more control and the cat less options to escape.

FIG. 7 depicts a cat wearing cat paw mitten apparel on each of his paws.

FIG. 8-12 Illustrates the process of applying the kitty paw mitten with one hand and without the use of straps, and with one step application as illustrated specifically in FIGS. 11, 12.

FIG. 8 Mitten is opened from the top with first hand by inserting fingers inside the mitten about the rim area and then is stretched open. Mitten is positioned over the second hand; lower portion of mitten is cupped in the palm of the second hand while the fingers, specifically the two index fingers and thumb are in a pinch position. The elastic rim portion of the mitten previously stretched in the first hand folds the over the opposite hands fingers in the pinch position. FIG. 11 By using the fingers and the thumb, kitty paw mitten is stretched open wide enough for the paw to fit into. FIG. 12 Paw is inserted into the mitten by second hand with an upward motion of the open mitten over the paw then released once mitten is over the paw far enough. Once released kitty paw can be freely adjusted as needed.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of animal apparel for “Cat Paw Mittens to Prevent Scratching During Bathtime” comprising:
a one piece mitten comprised flexible, cotton like, porous material shaped to fit over each cat paw, front and rear with one user friendly design;
a variable piece of dense reinforcement material affixed inside the mitten about the claw area for puncture resistance;
an elastic, rubber band, or other expandable seam at the top of the mitten that when stretched open provides an opening for the paw, and when released provides the instant closure or security; and
a variable piece of material(s) on the bottom of the mitten that when wet becomes slippery,.

2. An article of animal apparel for “Cat Paw Mittens to Prevent Scratching During Bathtime” as claimed in claim 1 wherein said one piece mitten is sized to fit a cats paw both front pairs and rear pairs which has an opening on the top for paw insertion and closed at the bottom

3. An article of animal apparel for “Cat Paw Mittens to Prevent Scratching During Bathtime” as claimed in claim 1 wherein said one piece mitten is user friendly by providing a one step process of application

4. An article of animal apparel for “Cat Paw Mittens to Prevent Scratching During Bathtime” as claimed in claim 1 wherein said one piece mitten is porous enough for suds to penetrate and be rinsed through while maintaining maximum fur exposure for the purpose of bathing

5. An article of animal apparel for “Cat Paw Mittens to Prevent Scratching During Bathtime” as claimed in claim 1 wherein said variable dense piece of reinforcement material is sewn or glued into the inner lining of the mitten positioned about the claws provides a protective barrier from claws penetrating through the mitten giving protection to the human from painful scratches

6. An article of animal apparel for “Cat Paw Mittens to Prevent Scratching During Bathtime” as claimed in claim 1 wherein said elastic, rubber band, or other expandable seam at the top of the mitten provides a one step process of closing by simply releasing it after being stretched open and placed over the paw then released into a tight hold

7. An article of animal apparel for “Cat Paw Mittens to Prevent Scratching During Bathtime” as claimed in claim 4 wherein said elastic or rubber band closure causes the material to gather in such a way that it catches the fur and aides in securing the mitten during bathtime making it difficult for the cat to shake it off and secure enough to stay on during bathtime and subsequently accommodating quick removal

8. An article of animal apparel for “Cat Paw Mittens to Prevent Scratching During Bathtime” as claimed in claim 1 wherein said variable piece of material(s) on the bottom of the mitten that when wet becomes slippery forces the cat to concentrate on maintaining balance while standing, while simultaneously taking away his ability to grip to execute a flee attempt giving the human more control of the cat during bathtime
